(19) United States
(12) Patent Application Publication
(10) Pub. No.: US 2008/0260021 A1
(43) Pub. Date: Oct. 23, 2008

(54) Method of digital video decompression, deinterlacing and frame rate conversion

(76) Inventor: Chih-Ta Star Sung, Glonn (DE)

Correspondence Address: Chih-Ta Star Sung, Rm. 308, Bld. 52, No. 195, Sec. 4, Chung Hsin Rd., Juhdong, 310, TW

(21) Appl. No.: 11/788,852

(22) Filed: Apr. 23, 2007

(51) Int. Cl. H04N 7/12

(52) U.S. Cl. 375/240.01

(57) ABSTRACT

The digital video decompression, de-interlacing and frame conversion are done simultaneously with multiple video decompressing engines decoding multiple fields/frames at a time. The on-chip line buffer temporarily stores multiple rows of macro-block pixels of the video decoding referencing field/frame and the reconstructed field/frame and are used simultaneously in de-interlacing and frame rate conversion.

### BACKGROUND OF THE INVENTION

1. Field of Invention

The present invention relates to digital video decompression, de-interlacing and frame rate conversion. And, more specifically to an efficient video bit stream decompression, de-interlacing and constructing new image directly from video decompression procedure which sharply reduces the 10 bandwidth requirement of the frame buffer.

2. Description of Related Art

ISO and ITU have separately or jointly developed and defined some digital video compression standards including MPEG-1, MPEG-2, MPEG-4, MPEG-7, H.261, H.263 and H.264. The success of development of the video compression standards fuels wide applications which include video telephony, surveillance system, DVD, and digital TV. The advantage of digital image and video compression techniques significantly saves the storage space and transmission time without sacrificing much of the image quality.

Most ISO and ITU motion video compression standards adopt Y, U/Cb and V/Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-type or P-type frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. While, the P-frame and B-frame have to code the difference between a target frame and the reference frames.

In compressing or decompressing the P-type or B-type of video frame or block of pixels, the referencing memory dominates high semiconductor die area and cost. If the referencing frame is stored in an off-chip memory, due to I/O data pad limitation of most semiconductor memories, accessing the memory and transferring the pixels stored in the memory becomes bottleneck of most implementations. One prior method overcoming the I/O bandwidth problem is to use multiple chips of memory to store the referencing frame which cost linearly goes higher with the amount of memory chip. Some times, higher speed clock rate of data transfer solves the bottleneck of the I/O bandwidth at the cost of higher since the memory with higher accessing speed charges more and more EMI problems in system board design. In MPEG2 TV application, a Frame of video is divided to be “odd field” and “even field” with each field being compressed separately which causes discrepancy and quality degradation in image when 2 fields are combined into a frame before display.

De-interlacing is a method applied to overcome the image quality degradation before display. For efficiency and performance, 3-4 of previous frames and future frames of image are used to be reference for compensating the potential image error caused by separate quantization. De-interlacing requires high memory I/O bandwidth since it accesses 3-5 frames.

In some display applications, frame rate or field rate need to be converted to fit the requirement of higher quality and the frame rate conversion is needed which requires referring to multiple frames of image to interpolate extra frames which consumes high bandwidth of memory bus as well.

The method of this invention of video de-interlacing and frame rate conversion coupled with video decompression and applying referencing frame compression significantly reduces the requirement of memory 10 bandwidth and costs less storage device.

### SUMMARY OF THE INVENTION

The present invention is related to a method of digital video de-interlacing with the referencing frame buffer compression and decompression which reduces the semiconductor die area/cost sharply in system design. This method sharply reduces the memory I/O bandwidth requirement if off-chip memory is applied to store the compressed referencing frame.

The present invention of this efficient digital video de-interlacing compresses and reduces the data rate of the digital video frames which are used as reference for video de-interlacing.

According to one embodiment of the present invention, the recompressed lines of multiple frames are used to de-interlacing and frame rate conversion by applying interpolation means when the video decoding is in process.

According to one embodiment of the present invention, multiple video decoding engines are running in parallel to reconstruct at least two fields/frames at a time and the already reconstructed two referencing frames/fields together with the two under reconstruction can be used to de-interlacing and interpolating to form new frame.

According to one embodiment of the present invention, a predetermined time is set to reconstruct a slice of blocks of Y and UN pixel components video de-interlacing and frame rate conversion by interpolation means.

According to one embodiment of the present invention, at least two lines of pixel buffer is designed to temporarily store a slice of decompressed blocks of Y and Cr/Cb pixel components for video de-interlacing and frame rate conversion.

According to another embodiment of the present invention, the line by line pixels formed by de-interlacing and by interpolating to form new video frame are separately writing into the frame buffer memory.

It is to be understood that both the foregoing general description and the following detailed description are by examples, and are intended to provide further explanation of the invention as claimed.

### BRIEF DESCRIPTION OF THE DRAWINGS

FIG. 1 shows the basic three types of motion video coding.

FIG. 2 depicts a block diagram of a video compression procedure with two referencing frames saved in so named referencing frame buffer.

FIG. 3. illustrates the block diagram of video decompression.

FIG. 4 illustrates Video compression with interlacing mode.

FIG. 5 depicts a prior art video decompression and de-interlacing.

FIG. 6 depicts basic concept of frame rate conversion.

FIG. 7 depicts prior art video decompression, de-interlacing and frame rate conversion.

FIG. 8 depicts present invention of video decompression, de-interlacing and frame rate conversion.

FIG. 9 illustrates the present invention of the mechanism of parallel decoding multiple frames, de-interlacing and interpolating new frame by using the same decompressed rows of macro-block pixels and the rows of macro-block of referencing fields/frames.

### DESCRIPTION OF THE PREFERRED EMBODIMENTS

There are essentially three types of picture coding in the MPEG video compression standard as shown in FIG. 1. I-frame 11, the “Intra-coded” picture, uses the block of pixels within the frame to code itself. P-frame 12, the “Predictive” frame, uses previous I-frame or P-frame as a reference to code the differences between frames. B-frame 13, the “Bi-directional” interpolated frame, uses previous I-frame or P-frame 12 as well as the next I-frame or P-frame 14 as references to code the pixel information.

In most applications, since the I-frame does not use any other frame as reference and hence no need of the motion estimation, the image quality is the best of the three types of pictures, and requires least computing power in encoding since no need for motion estimation. The encoding procedure of the I-frame is similar to that of the JPEG picture. Because of the motion estimation needs to be done in referring both previous and/or next frames, encoding B-type frame consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization step is larger than that in a P-frame. In most video compression standard including MPEG, a B-type frame is not allowed for reference by other frame of picture, so, error in B-frame will not be propagated to other frames and allowing bigger error in B-frame is more common than in P-frame or I-frame. Encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

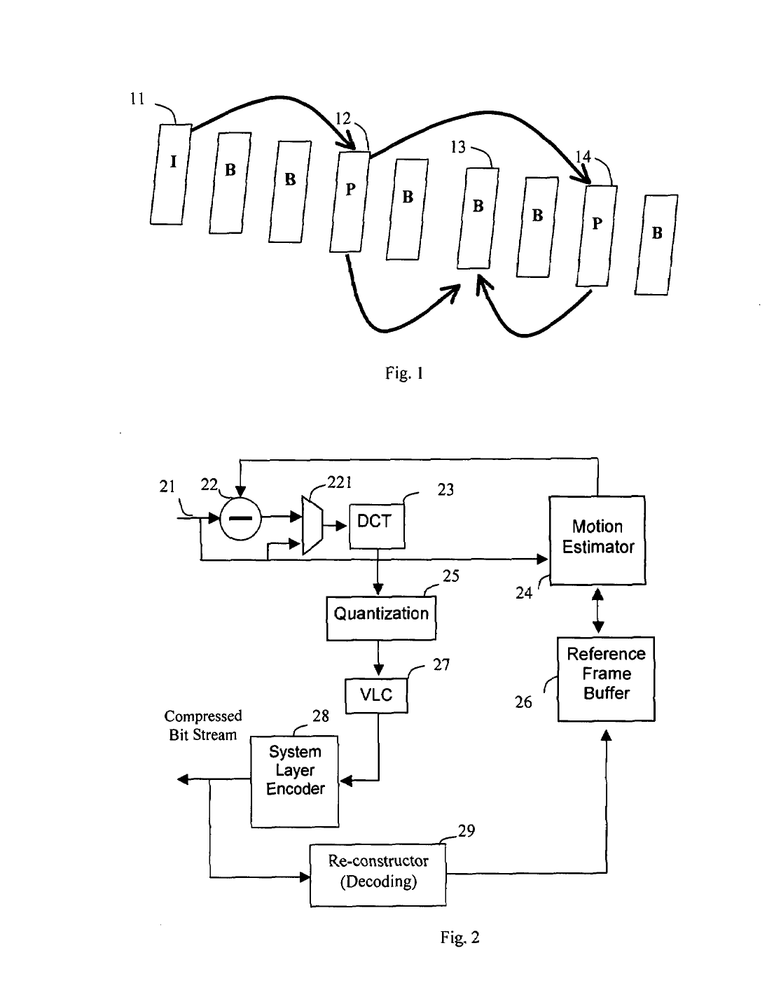

FIG. 2 shows the block diagram of the MPEG video compression procedure, which is most commonly adopted by video compression IC and system suppliers. In I-type frame coding, the MUX 221 selects the coming original pixels 21 to directly go to the DCT 23 block, the Discrete Cosine Transform before the Quantization 25 step. The quantized DCT coefficients are packed as pairs of “Run-Length” code, which has patterns that will later be counted and be assigned code with variable length by the VLC encoder 27. The Variable Length Coding depends on the pattern occurrence. The compressed I-type frame or P-type bit stream will then be reconstructed by the reverse route of decompression procedure 29 and be stored in a reference frame buffer 26 as future frames' reference. In the case of compressing a P-frame, B-frame or a P-type, or a B-type macro block, the macro block pixels are sent to the motion estimator 24 to compare with pixels within macroblock of previous frame for the searching of the best match macroblock. The Predictor 22 calculates the pixel differences between the targeted 8×8 block and the block within the best match macroblock of previous frame or next frame. The block difference is then fed into the DCT 23, quantization 25, and VLC 27 coding, which is the same procedure like the I-frame coding.

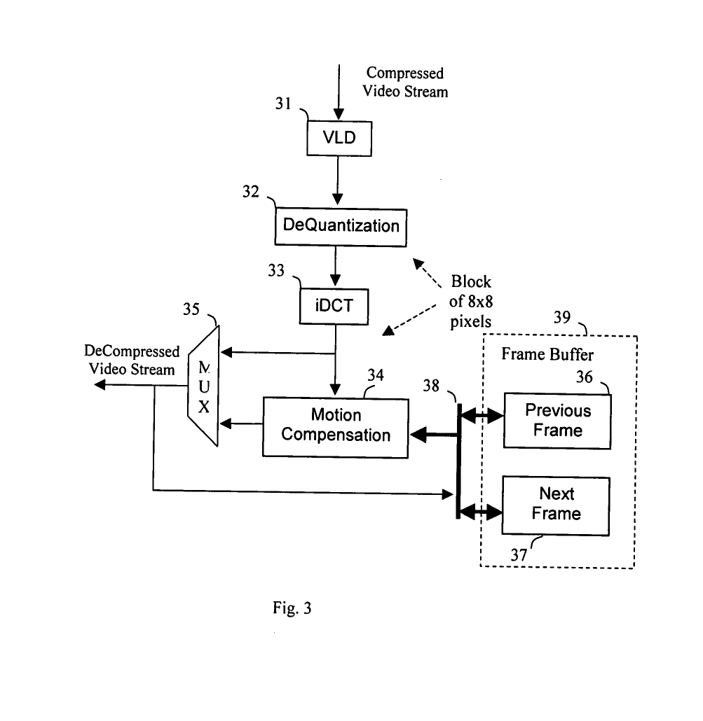

FIG. 3 illustrates the basic procedure of MPEG video decompression. The compressed video stream with system header having many system level information including resolution, frame rate, . . . etc. is decoded by the system decoder and sent to the VLD 31, the variable length decoder. The decoded block of DCT coefficients is shifted by the “Dequantization” 32 before they go through the iDCT 33, inverse DCT, and recovers time domain pixel information. In decoding the non intra-frame, including P-type and B-type frames, the output of the iDCT are the pixel difference between the current frame and the referencing frame and should go through motion compensation 34 to recover to be the original pixels. The decoded I-frame or P-frame can be temporarily saved in the frame buffer 39 comprising the previous frame 36 and the next frame 37 to be reference of the next P-type or B-type frame. When decompressing the next P-type frame or next B-type frame, the memory controller will access the frame buffer and transfer some blocks of pixels of previous frame and/or next frame to the current frame for motion compensation. Storing the referencing frame buffer on-chip costs high semiconductor die area and very costly. Transferring block pixels to and from the frame buffer consumes a lot of time and I/O 38 bandwidth of the memory or other storage device. To reduce the required density of the temporary storage device and to speed up the accessing time in both video compression and decompression, compressing the referencing frame image is an efficient new option.

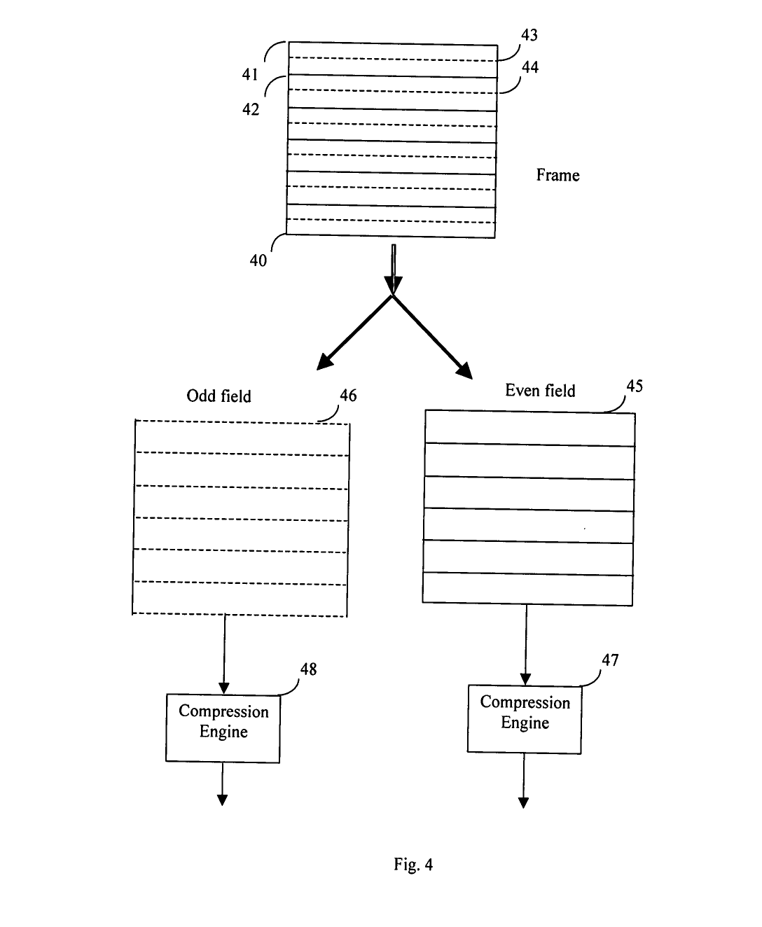

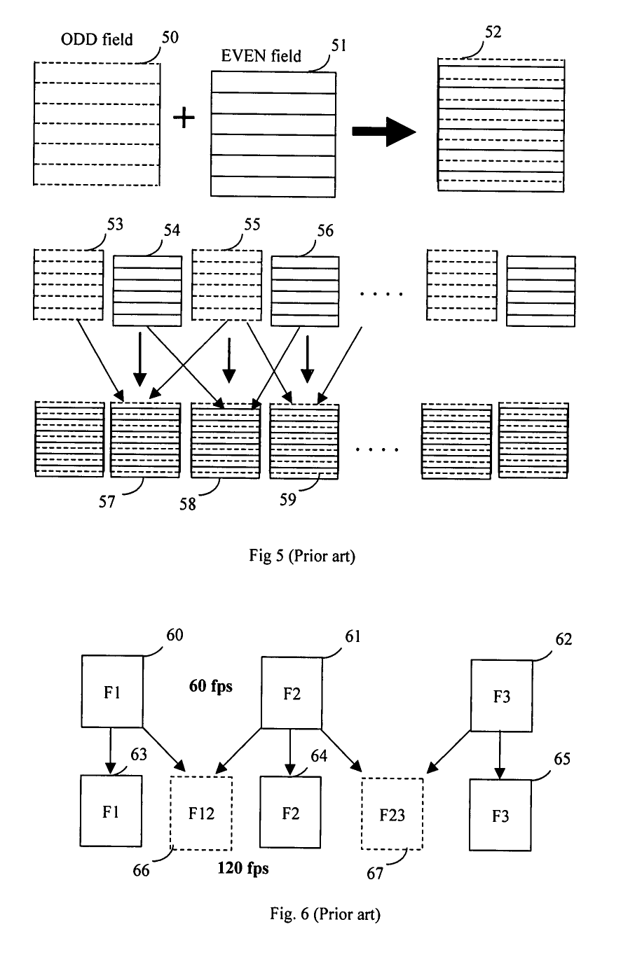

In some video applications like TV set, since the display frequency is higher than 60 frames per second (60 fps), most likely, interlacing mode is adopted, in which, as shown in FIG. 4, even lines 41, 42 and odd lines 43, 44 of pixels within a captured video frame will be separated and form “Eve field 45” and “Odd field 46” and compress them separately 48, 49 with different quantization parameters which causes loss and error and since the quantization is done independently, after decompression, when merging them to be a “frame” again, the individual loss of different field causes obvious artifacts in some area like edge of an object. In some applications including TV set as shown in FIG. 5, the interlaced images with odd field 50 and even field 51 will be re-combined to form “Frame” 52 again before displaying. The odd lines of even field position 57, 59 will be filled most likely by compensation means of adjacent odd fields 53, 55 . . . To minimize the artifact caused by video compression of interlacing mode, de-interlacing might apply not only adjacent previous and next fields, but also between 3 to 4 previous fields and 3-4 next fields for compensation and to reconstruct the odd or even lines of pixels. It is obvious that de-interlacing requires reading multiple previous and next files of pixels which cost high memory 10 bandwidth. Normally, a pixel will be read from the off-chip memory for 4-8 times for video de-interlacing and being written back once after de-interlacing is done.

Another procedure consuming a lot memory 10 bandwidth is the frame rate conversion which interpolates and forms new frame between decoded frames. For a video with 30 frames per second or said 30 fps converting to 60 fps, or from a 60 fps converting to 120 fps, the easiest way is to repeat very frame which can not gain good image quality. As shown in FIG. 6, one can also easily interpolates and forms a new frame 66, 67 between every two existing adjacent frames 60, 61, 62 which requires reading each pixel at least twice. For gaining even better image quality, multiple previous frame and multiple future frames are read to compensate and interpolate to form the new frame which consumes high memory IO bandwidth. In prior solution in De-Interlacing and frame rate conversion is they are done separately and require accessing the frame buffer memory for 6-8 times individually.

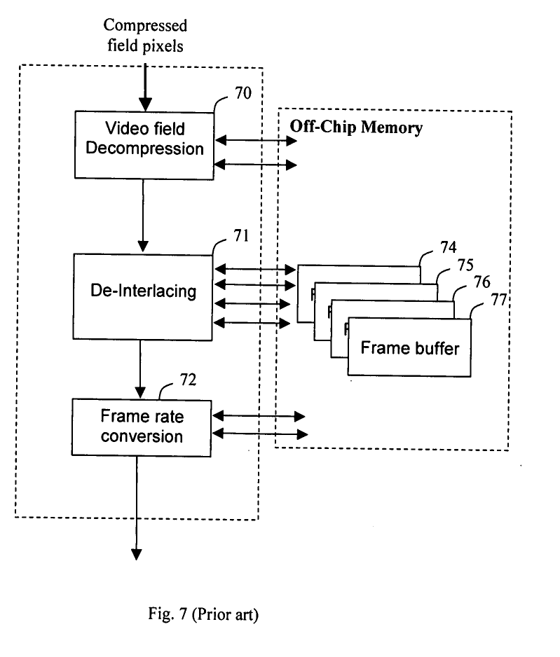

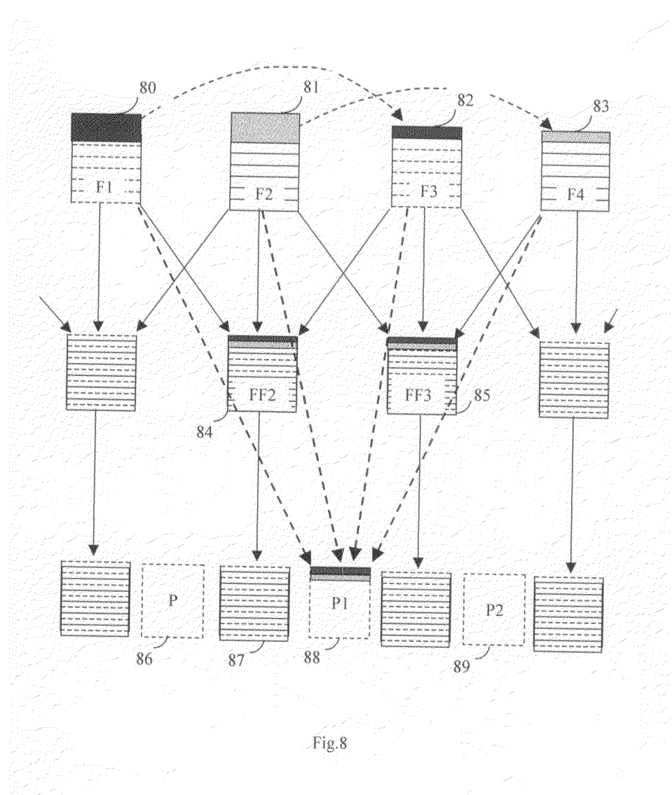

FIG. 7 depicts an example of the conventional means of the video decompression 70, de-interlacing 71 and frame rate conversion 72. Each of the three procedure requires high traffic in reading and writing pixels from and to the frame buffers. Due to the heavy traffic on memory bus, and since commodity memory has limited data width like SDRAM, DDR or DDR2 they have most likely 8 bits or at most 16 bits wide are the main stream which costs less compared to 32 bits wide memory chips. Applying some multiple memory chips 74, 75, 76, 77 becomes common solution to provide the required 10 bandwidth which is costly and results in difficulty in system board design and much EMI, Electro-Magnetic Interference problems can be introduced.

The present invention provides method of reducing the required bandwidth by buffering the decompressed lines of video image and applying these reconstructed lines of pixels to function as de-interlacing and interpolating to form the needed new frame of pixels and these two function of de-interlacing and frame rate conversion (or frame interpolation) are done by referring to those pixels temporarily stored in the line buffers. Therefore it avoids the need of multiple accessing the same referencing frame buffer.

FIG. 8 illustrates just an example of this invention of de-interlacing and frame rate conversion directly from the reconstructed lines of pixels. The reconstructed stripes of pixels in video decompression are used to be the reference of the following frame/field reference as like P3, 82 refers to P1, 80 and P4, 83 refers to P2, 81. The in most video compression standards, motion compensation is done in macro-block based which means, once the targeted frame has reconstructed more than 32 lines of pixels, these temporarily stored on-chip 32 lines pixels can be used to start decompressing the next frame/field pixels in parallel since the macro-block pixels are supposed to be compressed and also decompressed sequentially from left top to right bottom. Therefore, applying two video decoding engines and let them decompress 2 frame/field simultaneously, the reconstructed lines of fours fields/frames P1, P2, P3, P4, 80, 81, 82, 83 which are temporarily stored in the on-chip line buffer can start de-interlacing two frames FF2, FF3, 84, 85 and these four fields/frames can interpolate and form new frame 88, P1. When time goes on, the following future two frames/fields F5, F6 together with F3, F4 can de-interlacing two frames FF4, FF5 and interpolate to form new frame 89, P2.

FIG. 8 is just only an example using only two frames/fields for de-interlacing or fours fields/frames for frame rate conversion to illustrate the concept of this invention of video decoding, de-interlacing and frame rate conversion done in the same time.

To achieve higher image quality, 3-4 previous frames/fields and 3-4 previous frames/fields might be referred for de-interlacing, and/or for interpolation to construct new frame in frame rate conversion which consume much more 10 bandwidth. By applying this present invention, the pixels accessed from the referencing frame for video decompression and the reconstructed pixels are stored in the on-chip line buffer used for de-interlacing and frame rate conversion to form new frame without accessing multiple times of the referencing frame of pixels.

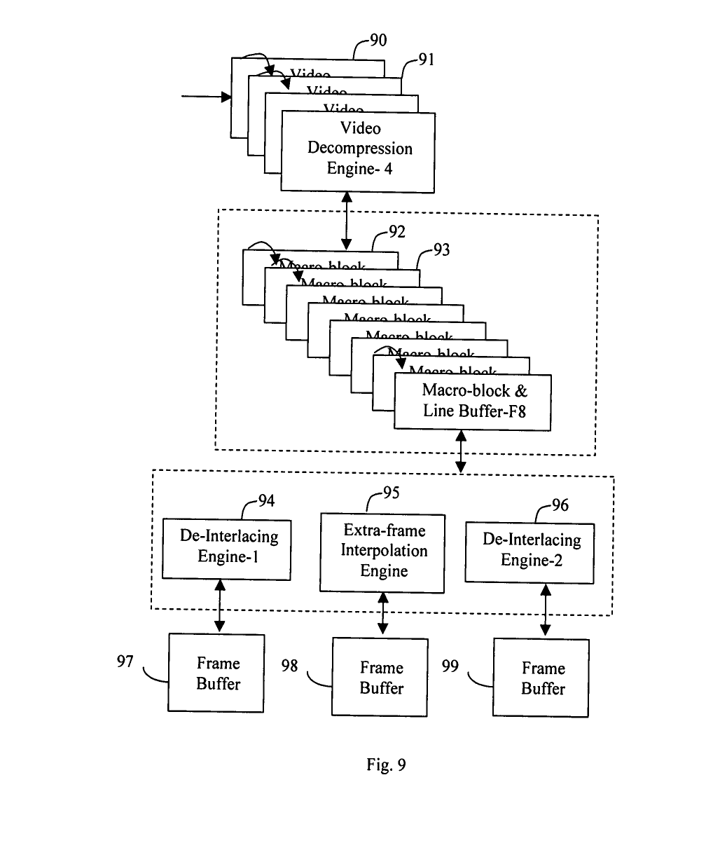

FIG. 9 depicts the device of realizing this invention of video decoding, de-interlacing and frame rate conversion. Multiple video decoding engines, for example, four video decoders 90, 91 will be implemented on the same system. Each of the video decoding engines will decompress the video frame/field simultaneously with each referring to its corresponding referencing frame/field pixels which might be saved in off-chip memory chip with corresponding on-chip lines buffer to temporarily storing multiple lines 92, 93 of the referencing frame/field pixels and another on-chip line buffer temporarily storing the reconstructed lines 92, 93 of pixels. It does not necessary to reconstruct the complete field/frame of image before starting video decompressing, de-interlacing and/or new frame/field interpolation. Just using the reconstructed lines of pixels (for example, the reconstructed 32 lines of pixels as shown in FIG. 8, F1/F2, 80, 81 can be used to decode F3/F4, 82, 83), the apparatus of this invention starts decompressing new video field/frame by referring to the reconstructed “Slice” or said “Row of macro-block” pixels and starts de-interlacing 94, 96 with reconstructed lines of pixel and starts interpolation 95 to form new frame/field of image. When decompressing field/frame image, de-interlacing and frame converting, the row of macro-block pixel of referencing pixels accessed from corresponding frame/filed 97, 98, 99 are saved in the on-chip line buffers. And the reconstructed row of macro-block pixels are written to the corresponding frame/field buffers 97, 98, 99. After de-interlacing and frame rate conversion, the on-chip line buffer can be overwritten by newly reconstructed row of macron-block pixels. In principle, to support macro-block of 16×16 pixels which is a standard shape of MPEG video, in this present invention, there will be a need of 4 rows of 16×16 macro-block pixel buffer for each field or frame which is equivalent to 48 lines of pixels. The top row of macro-block pixels are no longer need for video decoding, and are used for de-interlacing and frame rate conversion. Therefore, the top row of macro-block pixels in both referencing field/frame and field/frame under decoding are used for de-interlacing and frame rate conversion. When the new row of macro-block video starts decoding, the top row can be overwritten by newly decoded macro-block pixels.

Applying this invention, the decompressed rows of macro-block video frame of pixels stored in the on-chip line buffer can be referred for future field/frame decompression and de-interlacing as well as frame rate conversion before written to the frame buffer or other storage device and can avoid multiple accessing for de-interlacing and later for frame rate conversion.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of digital video compression, de-interlacing and frame rate conversion, comprising:
decompressing the corresponding rows of macro-blocks of pixels from at least two fields or frames and storing into the on-chip line buffer;
Simultaneously decompressing at least two corresponding video fields or frames, de-interlacing at least one video frame and constructing at least one new video frame by the following procedure:
Decompressing at least two video fields or frames at a time by referring to the decompressed or accessed corresponding macro-blocks pixels and storing the reconstructed macro-blocks of pixels into a temporary image line buffer;
De-interlacing and constructing the frame image by referring to the accessed referencing filed/frame pixels and reconstructed lines of pixels which are temporarily stored in the on-chip line buffers of multiple referencing fields or frames; and
Constructing new frame between the decompressed fields by interpolation means and referring to the accessed referencing filed/frame pixels and the reconstructed lines of pixels which are temporarily stored in the on-chip line buffer.

2. The apparatus of claim 1, wherein the accessed macro-block pixel of the referencing frame are referred in de-interlacing and be used to interpolate and form new video frame.

3. The apparatus of claim 1, wherein accessed macro-block pixel of the referencing frame and the reconstructed macro-block pixels are temporarily stored in a pixel buffer, and after the whole row of at least eight lines of pixels are completely reconstructed, the de-interlacing and frame rate conversion can refer to the complete line pixels.

4. The apparatus of claim 3, wherein the macro-block is comprised of at least 8×8 pixels in vide encoding and decoding and the motion compensation is done in macro-block based calculation.

5. The apparatus of claim 1, wherein the starting address of each row of macro-block is calculated by an on-chip calculator and sent to the memory controller for requesting the corresponding pixels of the referencing field/frame.

6. The apparatus of claim 1, wherein during de-interlacing, at least two previous fields/frames and two future fields/frames are referred in deciding the motion compensation of each pixel.

7. The apparatus of claim 1, wherein during frame rate conversion, at least two previous fields/frames and two future fields/frames are referred in calculating the motion compensation of each pixel.

8. A method of realizing the digital video compression, de-interlacing and frame rate conversion, comprising:
implementing at least two video decoding engines to allow simultaneously decompressing at least two corresponding video fields or frames, de-interlacing at least one video frame and constructing at least one new video frame by the following procedure:
decompressing at least two video fields or frames at a time by reading and saving the whole row of macro-blocks of reference frame/field into line buffer;
storing the accessed row of macro-blocks of reference frame/field and the reconstructed row of macro-blocks of pixels into a temporary image line buffer for de-interlacing and constructing new frames between the reconstructed fields/frames; and
writing the reconstructed row of macro-block pixels temporarily stored in the line buffer to the frame buffer when de-interlacing and frame rate conversion functions of the corresponding row of macro-blocks are completed, afterward, the line buffer can be overwritten with newly reconstructed macro-block of pixels for future de-interlacing and frame rate conversion.

9. The method of claim 8, wherein a predetermined size of line buffer temporarily saving the row of macro-block pixels of reference frame and the decompressed row of macro-block pixels is dependent on the resolution of video frame.

10. The method of claim 8, wherein a whole row of macro-block pixels of reference frame and the decompressed row of macro-block pixels is overwritten by newly reconstructed row of macro-block pixels.

11. The method of claim 8, wherein multiple video decoding engines are integrated into the same semiconductor chip to reconstruct rows of macro-block pixels simultaneously and are referred by de-interlacing and frame rate conversion.

12. The method of claim 8, wherein at least three rows of macro-block pixels buffer is implemented for each field or frame decoding with the top row of macro-block working for de-interlacing and frame rate conversion.

13. The method of claim 8, wherein at least three rows of macro-block buffer stores the referencing field/frame pixels with the top row of macro-block working for de-interlacing and frame rate conversion.

14. A method of high efficient digital video compression, comprising:
receiving compressed video stream of at least two frames and saving into an image buffer;
Simultaneously decompressing at least two video fields or frames by the following procedure:
decompressing the first three rows of macro-block pixels of the first video fields or frames and storing the reconstructed macro-blocks of pixels into a temporary image line buffer;
decompressing the second and further video fields or frames by referring to the reconstructed macro-blocks of pixels of the first field/frame pixel which is saved in a temporary image line buffer;
writing out the first row of macron-block pixels when the next future field/frame have decompressed its first row of macro-block pixels an no longer need the first row of macro-block pixels of the previous field/frame; and
decompressing lower rows of macro-block of pixels and saving into the line buffer of the first row of macron-block pixels when the future field/frame have decompressed an no longer need the first row of macro-block pixels;

15. The method of claim 14, wherein the line buffer saving at least four rows of macro-block pixels are implemented to temporarily save the decompressed pixels for each field/frame which are under decompression.

16. The method of claim 14, wherein the line buffer of pixels of top row of macro-block pixels of at least two video fields/frames are written to other storage device for displaying or other operation in the order of row by row of macro-block.
